(19) United States
(12) Patent Application Publication
(10) Pub. No.: US 2006/0151628 A1
(43) Pub. Date: Jul. 13, 2006

(54) Piezo sensor system for detecting the needle lift of a nozzle of a common rail injector

(76) Inventors: Nicholas Fekete, Stuttgart (DE); Tobias Flamig-Vetter, Esslingen (DE); Dirk Herbstritt, Durmersheim (DE)

Correspondence Address: WILLIAM COLLARD;COLLARD & ROE, P.C., 1077 NORTHERN BOULEVARD, ROSLYN, NY, 11576, US

(21) Appl. No.: 10/519,266

(22) PCT Filed: May 6, 2003
(86) PCT No.: PCT/EP03/09693

§ 371 Date: Jul. 18, 2005

(30) Foreign Application Priority Data
Jun. 25, 2002 (DE) 102 28 353.2

(51) Int. Cl. B05B 1/08

(52) U.S. Cl. 239/102.2

(57) ABSTRACT

The invention relates to a nozzle needle 4 of an injection nozzle 1, which is disposed within an injector housing and is biased against a housing shoulder 5 by way of a spring 2. A piezo-element 7 is between the spring 2 and the housing shoulder 5, to determine the nozzle needle path during opening and closing of the nozzle opening 3. For this purpose, the piezo-element 7 has two electrical connectors 8.1, 8.2 in the region of the faces 7.1, 7.2, respectively.

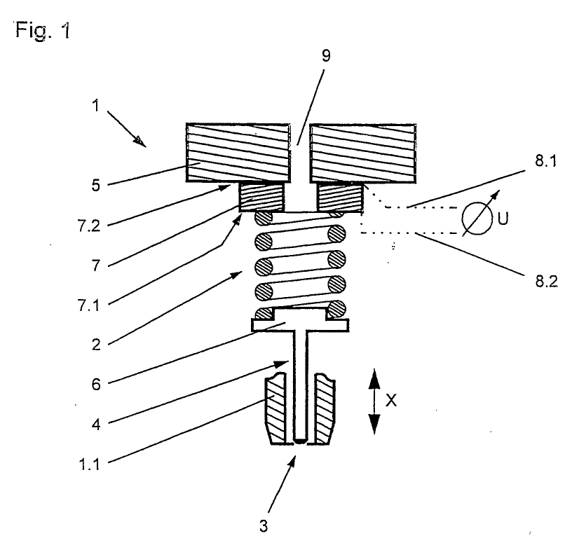

The invention relates to an injection nozzle for a common-rail injector, having a nozzle needle closing off a nozzle opening, biased by way of a spring, whereby the spring is disposed between a housing shoulder and a contact surface of the nozzle needle.

The injection amount and the start of injection are important characteristics for the optimal operation of diesel engines. Determining them permits the load-dependent and rpm-dependent adjustment of the injection process in a closed control circuit. The current methods for determining the needle stroke are imprecise, since the needle stroke is detected at a distance from the nozzle opening, i.e. the nozzle needle tip. The influence of a control piston, i.e. a connecting rod between a setting element and the nozzle needle falsifies the result.

An injection nozzle for fuel is already known from U.S. Pat. No. 6,235,736 B1. The injection nozzle has a nozzle needle as well as a control piston disposed axially to the nozzle needle. The control piston is biased upward via a first spring, and is set in the axial direction by way of a piezo-element. The nozzle needle is biased downward, in other words opposite to the control piston, by way of a second spring, and closes the nozzle opening in the bottommost position. By means of a movement of the control piston as the result of a setting movement of the piezo-element, the piston releases a flow-through opening for furl, so that the nozzle needle is moved out of its seat upward, counter to the spring force. After a stroke (h), the nozzle needle hits against a lower face of the control piston with its upper face, and thereby generates an additional upward setting force. As soon as the piezo-element is switched to be current-free, the control piston moves back into its upper end position and closes off the through-flow opening. The nozzle needle is then back in pressure force equilibrium, so that the resulting spring force performs the closing movement and closes the nozzle opening once again. The position of the nozzle needle is detected by way of the position of the control piston.

The invention is based on the task of configuring and arranging an injection nozzle in such a manner that optimal detection of the movement of the nozzle needle is guaranteed.

This task is accomplished, according to the invention, in that a piezo-element for detecting the spring force is provided between the housing shoulder and the spring. This achieves the result that the spring force resulting from the spring bias and the nozzle needle stroke, and therefore the setting movement of the nozzle needle is determined in simple manner. The piezo-element can be disposed directly behind the spring, so that no additional costs result from design changes.

It is advantageous that a piezo-element is provided between the contact surface of the nozzle needle and the spring. The resulting spring force and therefore the setting movement of the nozzle needle is also determined by means of the arrangement of the piezo-element between the nozzle needle and the spring.

For this purpose, it is advantageous that the piezo-element is configured to be ring-shaped or as a toroid having a first face and a second face lying opposite the first face, and has a first electrical connector in the region of the first face, and a second electrical connector in the region of the second face. The piezo-element is therefore disposed between the force introduction points of the spring and the housing shoulder or the contact surface, respectively, so that the load-dependent charge shift of the piezo-element is determined by way of the first and the second electrical connector.

Furthermore, it is advantageous that the setting path x of the nozzle needle can be determined by way of the function

$$x = \frac{Q}{{d}_{p} D}$$

where Q represents the charge of the piezo-element, dₚ represents the piezoelectric coefficient, and D represents the spring stiffness of the spring.

By means of the arrangement of the piezo-element within the very thick walls of the metal injection injector, any pick-up of magnetic and electrical alternating fields acting on the measurement signal is greatly attenuated.

For this purpose, it is also advantageous that the displacement charge can be determined in simple manner, by means of integration of the displacement current of the piezo-element during a movement.

Finally, according to a preferred embodiment of the solution according to the invention, it is provided that the intermediate values for the setting path x can be interpolated between two end positions of the setting path x of the nozzle needle. Both the resulting spring force and the piezo-element are linear with regard to the setting path x, i.e. the setting force, and have a very low hysteresis effect.

The decrease in stiffness of the spring as the result of aging, i.e. fatigue of the piezo-element, can be corrected by taking the drift in the measurement values into account.

The influence of the temperature results in an expansion of the nozzle needle and of the injector housing, as well as a change in the piezo-element characteristics. This temperature dependence is calculated by way of the maximal stroke and taken into consideration accordingly.

The dead time between the turn-on control signal for the setting element of the nozzle needle and the setting signal of the nozzle needle, according to the invention, which results from the mass inertia of the spring, can be used to uncouple the setting signal.

It is also advantageous that the housing shoulder and the piezo-element have a common opening disposed concentric to the piezo-element. In this opening, a setting element for the nozzle needle, not shown, is disposed.

Other advantages and details of the invention are explained in the claims and the description, and are shown in the drawing:

In the drawing, a detail of an injection nozzle 1 within an injector housing, shown in part, having a housing shoulder 5 and a lower housing part 1.1, is shown. In the housing part 1.1, a nozzle opening 3, which is opened and closed by way of a nozzle needle 4, is provided. The nozzle needle 4 has a contact surface 6 with which the nozzle needle 4 rests against a spring 2. As a counter-bearing on the side of the spring 2 opposite the nozzle needle 4, a piezo-element 7 is provided, which in turn rests against the housing shoulder 5. Thus the nozzle needle 4 is biased relative to the piezo-element 7 and the housing shoulder 5, by way of its contact surface 6 with the spring 2. In this connection, the piezo-element 7 is configured in cylindrical shape and has an average diameter that corresponds to the average diameter of the spring 2.

The piezo-element 7 has a first face 7.1 that rests against the spring 2, and a second face 7.2 that rests against the housing shoulder 5. In this connection, the first face 7.1 has a first electrical connector 8.1, and the second face 7.2 has a second electrical connector 8.2. The charge displacement current I within the piezo-element 7 is captured by way of the electrical connectors 8.1, 8.2. The opening movement x that proceeds from a closed, if applicable biased, position of the nozzle needle 4 generates a growth in force acting on the piezo-element 7, which is proportional to the setting path x, whereby the proportionality factor corresponds to the spring constant D. The setting path x of the nozzle needle 4 can thereby be determined, in simple manner, by means of the formula

$$x = \frac{Q}{{d}_{p} D}$$

where Q corresponds to the charge shift within the piezo-element 7 that occurs as a result of the change in force, and dₚ represents the piezoelectric coefficient.

1. Injection nozzle (1) for a common-rail injector, having a nozzle needle (4) closing off a nozzle opening (3) of the injection nozzle (1), biased by way of a spring (2), wherein the spring (2) is disposed between a housing shoulder (5) and a contact surface (6) of the nozzle needle (4), and a piezo-element (7) is provided between the spring (2) and the housing shoulder (5),
wherein
the housing shoulder (5) and the piezo-element (7) have a common opening (9), disposed concentric to the piezo-element (7), which extends from the housing shoulder (5) to the contact surface (6).

2. Device, particularly as recited in claim 1,
wherein
the piezo-element (7) is configured to be ring-shaped or as a toroid having a first face (7.1) and a second face (7.2) lying opposite the first face (7.1), and has a first electrical connector (8.1) in the region of the first face (7.1), and a second electrical connector (8.2) in the region of the second face 7.2.

3. Device as recited in claim 1,
wherein
the setting path x of the nozzle needle (4) can be determined by way of the function
$$x = \frac{Q}{{d}_{p} D}$$
where Q represents the charge of the piezo-element (7), dₚ represents the piezoelectric coefficient, and D represents the spring stiffness.

4. Device as recited in claim 1,
wherein
the displacement charge Q can be determined by means of integration of the displacement current of the piezo-element (7) during a movement.

5. Device as recited in claim 1,
wherein
the intermediate values for the setting path x can be interpolated between two end positions of the setting path x of the nozzle needle (4).

6. Device as recited in claim 1,
wherein
a piezo-element (7) is provided between the spring (2) and the contact surface (6).
